(19) United States
(12) Patent Application Publication
(10) Pub. No.: US 2005/0007618 A1
(43) Pub. Date: Jan. 13, 2005

(54) System for restricted execution of user requests for printing data

(76) Inventor: Tamra L. Thomason, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/615,643

(22) Filed: Jul. 7, 2003

(51) Int. Cl. G06F 15/00

(52) U.S. Cl. 358/1.14; 358/1.1

(57) ABSTRACT

Execution of user requests for printing data is restricted based on a set of one or more restricted user requests. A user request having a characteristic is received. It is determined whether the received user request is included in the set of one or more restricted user requests based on the characteristic of the received user request. An authorization indicator is received before printing data associated with the received user request when the received user request is included in the set of one or more restricted user requests.

### BACKGROUND

Printers provide hard-copy output from digital instructions, or print jobs, sent to the printers. Such print jobs are defined by user requests selecting data and print consumables, such as paper, ink, toner, and/or staples, among others, to create the particular form of output defined by each user request. The cost of executing each user request is related generally to the type and amount of print consumables specified by the user request. For example, color printing may be more expensive than black-and-white printing because of the increased cost of multiple dyes of different color over a single black dye. Similarly, printing images may be more expensive than printing text because more ink or toner may be used per page. Furthermore, printing long documents on many sheets of paper may incur a greater total cost for print media than printing a short document on a few sheets. Accordingly, it may be desirable to restrict execution of user requests based, for example, on the cost of executing each request, so that expensive or wasteful user requests are not executed indiscriminately.

Known approaches to limiting use of print consumables may be too restrictive, or too easy to override. For example, some networks restrict the use of particular printers on the network, regardless of the nature of the user requests. This very restrictive approach may be used to completely exclude a user from a particular printer, such as a high-end printer outfitted with expensive consumables. However, this approach may be impractical in many cases, such as in a small business or in a home where a single printer carries out all user requests. For example, this approach does not allow an adult to selectively restrict the use of a home printer by children based on what they want to print. In addition, this approach does not guard against accidental or inadvertent printing that wastes consumables, such as a request to print an unexpectedly long document, one document many times, or a text document in color, among others. In an alternative approach, default settings are used to reduce the use of consumables. For example, the default settings may specify black-and-white printing rather than printing in color, a cassette with lower-grade paper, and a single copy of the output. However, these settings may be changed easily in most configurations.

### SUMMARY

A method is provided for restricting execution of user requests for printing data. A set of one or more restricted user requests is defined. The restricted user requests are restricted according to characteristics associated with the restricted user requests. A user request having a characteristic is received. It is determined whether the received user request is included in the set of one or more restricted user requests based on the characteristic of the received user request. An authorization indicator is received before printing data associated with the received user request when the received user request is included in the set of one or more restricted user requests.

### BRIEF DESCRIPTION OF THE DRAWINGS

FIG. 1 is a perspective view of a system for restricting execution of user requests for printing data according to an embodiment of the present invention.

FIG. 2 is a schematic view of the system shown in FIG. 1.

FIG. 3 illustrates printing restrictions that may be included in the system of FIG. 2, the printing restrictions being juxtaposed with the selected printing mode and characteristic of an exemplary user request.

FIG. 4 is a flowchart presenting a method for restricting execution of user requests, according to an embodiment of the present invention.

### DETAILED DESCRIPTION

A system is provided, including method and apparatus, for restricting execution of user requests for printing data. Input may define a set of user requests to be restricted. The input may specify the restricted user requests according to characteristics of the restricted user requests. The characteristics may include printing modes selected, such as types of colorant (for example, printing with a single colorant versus multiple colorants), printing speeds/resolutions, paper sources, etc. Alternatively, or in addition, the characteristics may relate to an amount of something consumed by producing printed output, such as a number of print-media sheets, a quantity of colorant, an amount of time, an amount of power, and/or the like. In some embodiments, the input may define a threshold value for a characteristic. The threshold value may be specific for a particular selected printing mode (or subset of modes) so that user requests may be selectively restricted based on a combination of a selected printing-mode and a numerical characteristic of each user request.

When a user request is received, a determination may be made as to whether the characteristic of the received user request places such user request in the set of restricted user requests defined by the input. If so, an authorization should be received before executing the user request. The authorization to overcome the printing restriction so that print data associated with the received user request is sent to a printing device and printed may be an authorization indicator, for example, an predefined password, personal identification number (PIN), code, private key, etc. Accordingly, the system provided herein may reduce expenditures for print consumables and printer maintenance by limiting the frequency with which expensive and/or wasteful user requests are carried out.

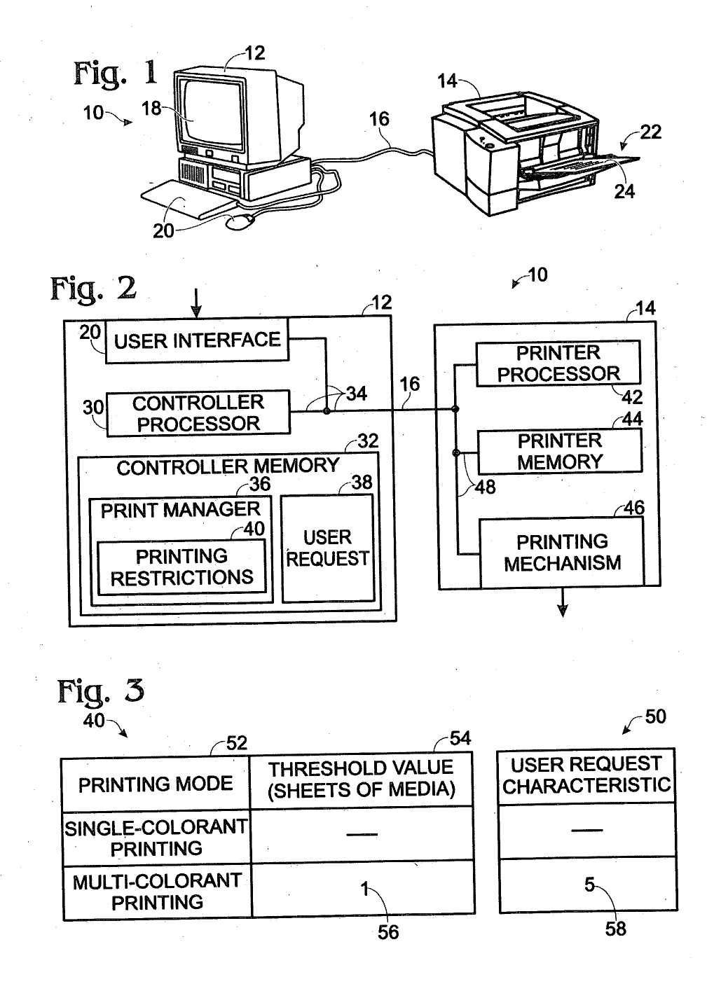

FIG. 1 is a perspective view of a system 10 for restricting execution of user requests for printing data. System 10 may include a controller 12 and a printer 14 operatively connected to the controller, such as through communications link 16.

Controller 12 may be any computing device capable of digitally processing data and sending a user request to printer 14. Accordingly, controller 12 may be a personal computer, a mainframe computer, a personal digital assistant, a cellular phone, a facsimile machine, or a photocopier, among others. Controller 12 may include an output display 18, a user interface 20 (such as a keyboard, keypad, and/or a mouse) and additional circuitry and devices for digital manipulation as described below. In some embodiments, controller 12 may be integral to printer 14, for example, when printer 14 includes a keyboard interface.

Printer 14 may be any printing device configured to provide hard-copy printed output 22. Exemplary printers apply a colorant or dye, such as ink or toner, to print media 24 (such as paper, metal, glass, plastic, wood, etc.) in a spatial pattern on the media. The spatial pattern may be defined by data associated with a user request. Suitable printers may include, but are not limited to, inkjet printers, laser printers, dot-matrix or ribbon printers, photocopiers, and facsimile machines.

Communications link 16 may include any connection that allows exchange of data, particularly data associated with a user request, between controller 12 and printer 14. Exemplary connections may include electrically conductive materials (such as wires or cables), an optical connection (such as with fiber-optic cable), and/or a wireless connection that exchanges data through air (for example, using electromagnetic radiation such as microwaves, infrared signals, radio waves, etc.). Communications link 16 may include a LAN (local area network) or a WAN (wide area network), such as the Internet, or may be a direct connection.

FIG. 2 is a schematic view of system 10. Controller 12 of system 10 may have a controller processor 30 and controller memory 32, coupled to one another and to user interface 20 using routing circuitry 34. Controller processor 30 may include any processing device configured to perform digital manipulation of data.

Controller memory 32 may be virtually any mechanism for storing digital information. Exemplary memories may include types of ROM (such as EEPROM or flash memory), RAM, and/or magnetic or optical storage devices. In FIG. 2, controller memory 32 is shown to include a print manager 36 and one or more received user requests 38.

Print manager 36 generally includes any instructions configured to control generation of printed output by printer 14 using data associated with user request 38. Accordingly, print manager 36 may include one or more printer drivers that translate the data into a format recognized by printer 14, such as a page description language in the form of a print job. In addition, print manager 36 may employ a set of printing restrictions 40 that specify which received user requests need authorization before they are executed by printer 14. Print manager 36 also may employ a set of digital instructions for identifying characteristics of received user requests 38, and for determining whether those characteristics place or include the received user requests in the set of restricted user requests. When a received user request is included in (or belongs to) the set, the print manager may request authorization from a person that sent the received user request, before sending the received user request in the form of a print job to the printer. Portions of print manager 36 may be secure, that is, accessible only by a printer administrator. The secure portions of the print manager may include not only the printing restrictions, but also may specify a set of one or more acceptable authorization indicators (such as a password) that may provide authorization for executing restricted user requests. One (or more) of the specified authorization indicators should be received, generally from the person that sent the received user request, before executing the received user request when deemed restricted.

User request 38 may be associated with data for which output is requested. Print data also referred to as user request data may be defined through user interface 20 (for example, by typing during word processing), received by file transfer from another site, produced by a digital imaging device, generated by manipulation with a software application, etc. Accordingly, the print data may correspond to printed output that includes text, an image, a printed photograph or drawing, and/or the like.

Printer 14 of system 10 may have, but is not limited to, a printer processor 42, printer memory 44, a printing mechanism 46, and connective circuitry 48. Printer processor 42 may include any device for manipulating digital information. The printer processor may work in cooperation with printer memory 44 to manipulate and store printing instructions received from controller 12 through communications link 16 and connective circuitry 48. In some embodiments, printer memory 44 may include at least some portions of print manager 36 and/or printing restrictions 40.

After any necessary or desired manipulation of the print data received from controller 12, the print data may be sent to printing mechanism 46 for printing. Printing mechanism 46 thus may include suitable mechanisms for depositing colorants positionally on print media, including a colorant delivery mechanism to apply the colorant(s) and a print-media positioning mechanism to provide relative movement between the print media and the colorant delivery mechanism.

FIG. 3 illustrates printing restrictions 40 juxtaposed with an exemplary user request, shown at 50. Printing restrictions 40 may define a set of user requests that are restricted, that is, require authorization before execution. In some embodiments, the user requests may be restricted according to characteristics of the user requests, such as printing mode 52 selected by the requests and/or according to a threshold value 54 for a numerical characteristic of the user requests.

Printing mode 52 may include any user-selectable approach by which a printing device produces and/or organizes printed output. Accordingly, each printing mode may be selected from among two or more options. The mode may be a printing preference, such as choice of colorant, printing resolution, printing speed, print-media source, type of print media, style of output sorting, style of output binding, surface coating, and/or position/order of colorant deposition, among others.

Choice of colorant may include, for example, selection between a single colorant and multiple colorants, to achieve single-color or multi-color printing on print media, as shown in FIG. 3. In exemplary embodiments, the single colorant may be black ink for black-and-white (or gray-scale) printing and the multiple colorants may be cyan, magenta, yellow, and black for color printing.

Choice or printing resolution or printing speed may be defined as printing quality. Choice of printing resolution may include, for example, selection between low, medium, and high printing resolutions, or selection of a numerical resolution. Printing speed choices may include, for example, selection between different rates of printing. In some embodiments, selection of printing speed and resolution may be interlinked.

Choice of print-media source may include, for example, selection of a particular site, such as a paper cassette or manual feed location, among others, from which print media is to be obtained during printing. Selection of a print media type, such as standard paper or photograde paper, as a printing preference also may define, for example, a printing mode optimized for a particular print media type.

Choice of style of output sorting may include, for example, how the printed output is organized or positioned. Selection of style of output binding may include, for example, whether the printed output is unstapled, stapled, bound along an edge, etc.

Choice of a surface coating may include, for example, presence or absence of a protective and/or decorative layer on the media or media and colorant, such as by lamination.

Position and/or order of colorant deposition may include, for example, selection of single-sided or double-sided printing, portrait versus landscape orientations, or selection of single-pass or multiple-pass printing, among others.

Threshold value 54 may include any cutoff at which a user request is restricted. The threshold value(s) may correspond to any characteristic of a user request and may be dependent on, or independent of, the identity of a person that sent the received user request. The characteristic to which the threshold value corresponds may be defined according to an aspect of printed output specified by the user request. Accordingly, the characteristic may be a predicted or expected aspect that would result from executing the user request. Expected characteristics may include size of printed output, amount of media to be used, amount of colorant to be used, printing duration, amount of power to be consumed, number of staples to be used, and/or the like. The size of printed output may be measured, for example, as a number of printed pages (sides or sheets), printed surface area, etc. More generally, the characteristic may relate to an amount and/or type of any consumable expected to be consumed by executing the printing request. Alternatively, or in addition, the characteristic may be an intrinsic aspect of the user request, such as digital size.

Threshold values may correspond to a selected printing mode, so that the threshold value applies selectively to that printing mode. Different printing modes may be assigned the same or different threshold values independently. For example, multi-colorant printing may be more restricted than single-colorant printing. In this case, a selective restriction may apply to multi-colorant printing relative to single-colorant printing. User requests for multi-colorant printing that are included in the selective restriction may require authorization before printing data associated with such requests, whereas user requests that specify single-colorant printing of the same data may not require authorization.

FIG. 3 shows single-colorant printing with no assigned threshold value. Accordingly, in the exemplary illustration, user requests selecting a single-colorant printing mode are not restricted according to amount of print media to be used. However, any suitable threshold value may be assigned to a single-colorant printing mode. When a threshold value is assigned, such as the value of “1” listed adjacent multi-colorant printing, shown at 56, the value may define a limit for unrestricted printing with that printing mode. The value may correspond to a maximum number of sheets allowable without restriction or to a number of sheets at or above which user requests are restricted. Accordingly, the restricted set of user requests for multi-colorant printing may request printed output on two or more sheets (characteristic greater than the threshold value) or on any number of sheets above zero (characteristic equal to or greater than the threshold value). In some embodiments, a page limit may apply to all user requests, with a greater restriction on particular printing modes.

More than one type of printing mode or characteristic may be restricted with printing restrictions 40. For example, the restrictions may define a set of user requests restricted according to colorant printing mode, another set restricted according to printing resolution, a third set restricted according to print-media source, and so on. Thus, a user request may be restricted that belongs to any of these restricted sets, so that the overall set of restricted user requests may be the union of these different sets.

FIG. 3 also indicates the characteristic of an exemplary user request 50. User request 50 specifies multi-colorant printing with a characteristic of “5,” shown at 58. The characteristic of “5” corresponds to the number of sheets of print media to be used during multi-colorant printing of data associated with user request 50. In the present illustration, “5” is greater than the threshold value of “1,” so user request 50 requires authorization before execution. If the same user request had specified single-colorant printing instead, no authorization would be required in this example. In some embodiments, an alternative, unrestricted printing mode may be suggested as an alternative when a restricted mode has been selected.

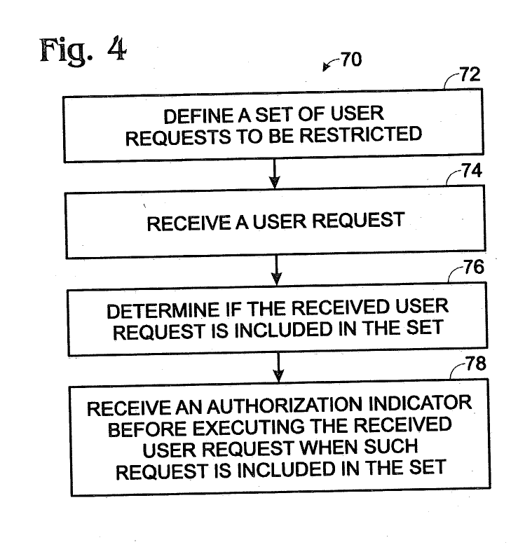

FIG. 4 is a flowchart presenting a method 70 of restricting execution of user requests. A set of restricted user requests may be defined, as shown at 72. The set may be predefined, for example, received as input at a controller or at the printing device to which the user requests are directed. The input may be received, for example, from an administrator of the printing device. The administrator is any person or group of people authorized to control use of the printing device by others. The printer administrator is different from a person (or persons) that sends user requests to the controller for execution. Alternatively, or in addition, the input may be received during manufacture of the controller or printing device. The input may restrict user requests according to one or more characteristics of each user request. In addition, the input may specify a set of at least one authorization indicator, one or more of which should be received to authorize the user request, when restricted. Each authorization indicator may be a password, a code, a string of characters, a private key, and/or the like. Accordingly, the set of authorization indicators may be a set of at least one password, code, and so on.

A user request may be received, as shown at 74. The received user request may be associated with print data to be printed by the printing device. In addition, the received user request may have a characteristic(s), as described above. In some embodiments, the characteristic may be related to a printing mode and/or may be numerical.

The method also may include determining if the received user request is included in the set of restricted user requests, as shown at 76. For example, the characteristic of the received user request, such as the selected printing mode(s), may be compared with restricted printing modes received as input at 72. Alternatively, or in addition, a numerical characteristic(s) of the received user request may be compared to a threshold value(s) for the numerical characteristic(s). The threshold value(s) may be specific for a particular printing mode(s).

Method 70 also may include receiving an authorization indicator before executing the user request when the received user request is included in the restricted set, as shown at 78. Receiving the authorization indicator may occur at any time in method 70, but preferably after receiving the user request. Furthermore, receiving the authorization indicator also may include requesting the authorization indicator when the received user request is included in the set of restricted user requests. The authorization indicator may correspond to one or more of such indicators defined by the input. For example, a person providing a user request may be presented with a message indicating that the received user request is restricted and will not be executed without suitable authorization. In this case, the received user request may be executed upon receipt of one of the specified authorization indicators. Executing the received user request may include creating a print job at the host controller and/or sending the print job to a printing device.

The authorization indicator may be received by any suitable mechanism. Exemplary mechanisms may include receiving an authorization indicator from a keyboard interface, an optical interface (for example, sent with visible light, infrared light, etc.), a magnetic interface (such as a card reader to read a magnetic storage device), and an electronic interface (such as from an electronic memory chip), among others.

It is believed that the disclosure set forth above encompasses multiple distinct embodiments. While each of these embodiments has been disclosed in specific form, the specific embodiments thereof as disclosed and illustrated herein are not to be considered in a limiting sense as numerous variations are possible. The subject matter of this disclosure thus includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

1. A method of restricting execution of user requests for printing data, comprising:
defining a set of one or more restricted user requests, such restricted user requests being restricted according to characteristics associated with such restricted user requests;
receiving a user request having a characteristic;
determining whether the received user request is included in the set of one or more restricted user requests based on the characteristic of the received user request; and
receiving an authorization indicator before printing data associated with the received user request when the received user request is included in the set of one or more restricted user requests.

2. The method of claim 1, wherein the characteristic of the received user request relates to a selected printing mode for printing the data, the selected printing mode specifying at least one of printing colorant, printing resolution, printing speed, print media source, type of print media, output sorting, output binding, and surface coating disposed on output.

3. The method of claim 1, wherein the received user request defines an aspect of a print job, and wherein printing data includes sending the print job to a printing device.

4. The method of claim 3, wherein the user request is received from a person, and wherein defining includes receiving input specifying the set of one or more restricted user requests from an administrator of the printing device, the administrator being different than the person.

5. The method of claim 1, wherein the characteristic is a numerical characteristic, and wherein at least one of the one or more restricted user requests defines a threshold value for the numerical characteristic, determining being based on a comparison of the numerical characteristic and the threshold value.

6. The method of claim 5, wherein the numerical characteristic relates to printed output produced by executing the received user request, and wherein the numerical characteristic is at least one of size of printed output, amount of print media included in the printed output, amount of colorant consumed to produce the printed output, duration of printing to produce the printed output, and amount of power consumed in producing the printed output.

7. The method of claim 1, wherein the authorization indicator is at least one of a password, a code, a string of characters, and a private key, and wherein receiving the authorization indicator includes requesting the authorization indicator after receiving the user request when the received user request is included in the set of one or more restricted user requests.

8. The method of claim 1, which further comprises suggesting an alternative, unrestricted characteristic upon determining that the received user request is included in the set of one or more restricted user requests.

9. A method of restricting execution of user requests for printing data, comprising:
defining a set of one or more restricted user requests according to printing modes and numerical characteristics associated with such restricted user requests;
receiving a user request selecting a printing mode and having a numerical characteristic;
determining whether the received user request is included in the set of restricted user requests based on the printing mode selected and the numerical characteristic of the received user request; and
receiving an authorization indicator before printing data associated with the received user request when the received user request is included in the set of one or more restricted user requests.

10. The method of claim 9, which further comprises suggesting an alternative, printing mode upon determining that the received user request is included in the set of one or more restricted user requests.

11. The method of claim 9, wherein the printing modes associated with the set of restricted user requests include multi-colorant printing.

12. The method of claim 9, wherein the numerical characteristics associated with the set of restricted user requests include sizes of output.

13. The method of claim 9, wherein at least one of the one or more restricted user requests defines a threshold value for the numerical characteristic, and wherein determining is based on a comparison of the numerical characteristic of the received user request to the threshold value.

14. The method of claim 9, wherein the numerical characteristic of the received user request relates to an amount of a consumable expected to be consumed by printing the data associated with such received user request.

15. The method of claim 9, wherein defining includes receiving input that places a greater restriction on multi-colorant printing than on single-colorant printing.

16. The method of claim 15, wherein the input restricts any received user request that specifies printed output having a size over a specified page limit.

17. A method of restricting execution of user requests for printing data, comprising:
defining a selective restriction on multi-colorant printing relative to single-colorant printing, the selective restriction including a page limit for multi-colorant printing;
receiving a user request specifying single-colorant or multi-colorant printing and defining a number of pages to be printed;
determining whether the received user request is included in the selective restriction based on the number of pages to be printed and the single-colorant or multi-colorant printing specified; and
receiving an authorization indicator before printing data associated with the received user request when the received user request is included in the selective restriction.

18. The method of claim 17, wherein the authorization indicator is at least one of a password, a code, a string of characters, and a private key.

19. The method of claim 17, wherein the received user request is sent by a person, and wherein receiving the authorization indicator includes requesting the authorization indicator from the person after receiving the user request.

20. A system for controlling execution of user requests for printing data, comprising:
a printing device configured to print data associated with user requests; and
a controller coupled with the printing device and including a set of restricted user requests according to characteristics associated with such restricted user requests, the controller having a received user request that has a characteristic, the controller being configured to determine if the received user request is included in the set of restricted user requests based on the characteristic of such received user request, and also configured to receive an authorization indicator before allowing the printing device to print data associated with the received user request when the received user request is included in the set of restricted user requests.

21. The system of claim 20, the controller being included in a separate device that is connected to the printing device.

22. A program storage device readable by a processor, tangibly embodying a program of instructions executable by the processor to perform method steps for controlling execution of user requests for printing data, the method steps comprising:
defining a set of one or more restricted user requests, such restricted user requests being restricted according to characteristics associated with such restricted user requests;
receiving a user request having a characteristic;
determining whether the received user request is included in the set of one or more restricted user requests based on the characteristic of the received user request; and
receiving an authorization indicator before allowing the printing device to print data associated with the received user request when the received user request is included in the set of one or more restricted user requests.

23. The program storage device of claim 22, wherein the characteristic is a numerical characteristic, determining being based on a comparison of the numerical characteristic and a threshold value.

24. The program storage device of claim 23, wherein the numerical characteristic relates to printed output produced by executing the received user request, and wherein the numerical characteristic is at least one of size of printed output, amount of print media included in the printed output, amount of colorant consumed to produce the printed output, duration of printing to produce the printed output, and amount of power consumed in producing the printed output.
